(19) United States
(12) Patent Application Publication
(10) Pub. No.: US 2018/0025651 A1
(43) Pub. Date: Jan. 25, 2018

(54) SYSTEMS AND DEVICES TO CONTROL ANTENNA AZIMUTH ORIENTATION IN AN OMNI-DIRECTIONAL UNMANNED AERIAL VEHICLE

(71) Applicant: TAOGLAS GROUP HOLDINGS LIMITED, Enniscorthy (IE)

(72) Inventor: Christopher M. ANDERSON, Minneapolis, MN (US)

(73) Assignee: TAOGLAS GROUP HOLDINGS LIMITED, Enniscorthy (IE)

(21) Appl. No.: 15/647,480

(22) Filed: Jul. 12, 2017

Related U.S. Application Data
(60) Provisional application No. 62/363,936, filed on Jul. 19, 2016.

(51) Int. Cl. G08G 5/00; B64C 39/02; H01Q 1/28; H01Q 3/00; G05D 1/00

(52) U.S. Cl. CPC G08G 5/0069; G08G 5/0013; G08G 5/0082; G08G 5/0034; H01Q 3/005; G05D 1/0022; H01Q 1/28; B64C 39/024

(57) ABSTRACT

Disclosed is the use of a fixed, directional antenna mounted on a surface of an omni-directional UAV. An orientation of the UAV is altered as a result of a pitch-roll-yaw command executed by the UAV to position the fixed, directional antenna optimally towards the base station.

### CROSS-REFERENCE

This application claims the benefit of U.S. Provisional Application No. 62/363,936, filed Jul. 19, 2016, entitled Systems and Devices to Control Antenna Azimuth Orientation in an Omni-Directional Unmanned Aerial Vehicle, which application is incorporated herein by reference.

### BACKGROUND

As unmanned aerial vehicle (UAV), or drone, technology progresses, each successive generation is driven by the need for lower costs and greater reliability, particularly in commercial and recreational applications. Additional benefits accrue from reducing weight and complexity of UAV components and systems. Achieving these goals produces additional benefits in the form of greater efficiency as well as increased range and payload capacity.

A critical aspect across all UAV applications is robustness and reliability of communications between the vehicle and its ground station. Often, this entails the use of complex or multiple, relatively massive antennas to provide acceptable three-dimensional (3D) gain. Another approach involves use of antenna steering systems to orient a directional antenna in a preferred alignment for reliable communication. These solutions are at odds with reducing complexity and weight and increasing systems reliability of UAVs.

What is needed is a way to integrate a relatively simple, lightweight fixed, directional antenna onto a UAV and maintain a preferred alignment of the UAV for reliable communications between the UAV and a base station during flight of the UAV.

### SUMMARY

A fixed, directional antenna is mounted on a surface of an omni-directional UAV such as a quad-copter. Preferred antenna alignment to a base station is achieved via at least one of a pitch-roll-yaw axis correction command issued to, and executed by the vehicle's flight control system to orient the UAV and its fixed antenna along the desired azimuth with respect to the ground control station. Calculation of the correct azimuth and issuance of the axis correction command is based on the relative positions of the UAV and the ground control station and may be performed either at the ground control station or on the UAV itself.

An aspect of the disclosure is directed to unmanned aerial vehicle systems. Suitable systems comprise: an unmanned aerial vehicle having a fixed, directional antenna, a rotational orientation detector, an absolute location detection system, and a flight control system; a base station having an RF transceiver, an azimuth computation unit, a rotational orientation detector, and an absolute location detection system in wireless communication with the unmanned aerial vehicle wherein the base station is configured to receive absolute location data, such as compass data, from the unmanned aerial vehicle rotational orientation detector and calculate an orientation of the unmanned aerial vehicle. The unmanned aerial vehicle can further comprise at least one of a pitch, roll and yaw corrector. Instructions can be sent from the base station based on, for example, a compass heading. The base station can be configured to generate an instruction to the unmanned aerial vehicle in response to the calculated orientation of the unmanned aerial vehicle. In alternative configurations, the instruction can be generated by a CPU onboard the unmanned aerial vehicle. The unmanned aerial vehicle can be autonomous such that the system is used to keep the antenna pointed as desired. The instructions to the unmanned aerial vehicle can change one or more of a pitch, roll and yaw of the unmanned aerial vehicle.

Another aspect of the disclosure is directed to unmanned aerial vehicle systems comprising: an unmanned aerial vehicle having a fixed, directional antenna, a rotational orientation detector, an absolute location detection system, a flight control system and an azimuth computation unit; a base station having an RF transceiver, and a control station absolute location detection system, in wireless communication with the unmanned aerial vehicle wherein the base station is configured to receive absolute location data from the unmanned aerial vehicle rotational orientation detector and calculate an orientation of the unmanned aerial vehicle. In some configurations, the unmanned aerial vehicle further comprises at least one of a pitch, roll and yaw corrector. Additionally, the base station can be Instructions can be sent from the base station based on, for example, a compass heading. Configured to generate an instruction to the unmanned aerial vehicle in response to the calculated orientation and/or location of the unmanned aerial vehicle. In alternative configurations, the instruction can be generated by a CPU onboard the unmanned aerial vehicle. The instruction to the unmanned aerial vehicle changes one or more of a pitch, roll and yaw of the unmanned aerial vehicle.

Still another aspect of the disclosure is directed to a method of controlling an unmanned aerial vehicle system comprising: an unmanned aerial vehicle having a fixed, directional antenna, a rotational orientation detector, an absolute location detection system, and a flight control system; a base station having an RF transceiver, an azimuth computation unit, a rotational orientation detector, and an absolute location detection system in wireless communication with the unmanned aerial vehicle wherein the base station is configured to receive an absolute location data from the rotational orientation detector and calculate an orientation of the unmanned aerial vehicle, the method steps comprising: establishing a wireless communication link between the aerial vehicle and the base station; determining a location and orientation of the unmanned aerial vehicle; calculating an instruction for the flight control system to change one or more of a pitch, roll and yaw of the unmanned aerial vehicle to change an orientation of the fixed, directional antenna. Additional steps can include generating an instruction to the unmanned aerial vehicle in response to the calculated orientation and/or location of the unmanned aerial vehicle. Additional steps can include sending the instruction to the unmanned aerial vehicle from the base station.

Yet another aspect of the disclosure is directed to a method of controlling an unmanned aerial vehicle system comprising: an unmanned aerial vehicle having a fixed, directional antenna, a rotational orientation detector, an absolute location detection system, a flight control system and an azimuth computation unit; a base station having an RF transceiver, and a control station absolute location detection system in wireless communication with the unmanned aerial vehicle wherein the base station is configured to receive an absolute location data from the rotational orientation detector and calculate an orientation of the unmanned aerial vehicle, the method steps comprising: establishing a wireless communication link between the aerial vehicle and the base station; determining a location of the unmanned aerial vehicle; calculating an instruction for the flight control system to change one or more of a pitch, roll and yaw of the unmanned aerial vehicle to change an orientation of the fixed, directional antenna. Additional steps can include generating an instruction to the unmanned aerial vehicle in response to the calculated orientation of the unmanned aerial vehicle. The method can also include sending the instruction to the unmanned aerial vehicle from the base station.

An aspect of the disclosure is directed to unmanned aerial vehicle systems. Suitable systems comprise: an unmanned aerial vehicle having a fixed, directional antenna means, a rotational orientation detector means, ab absolute location detection system, and a flight control system; a base station having an RF transceiver, an azimuth computation unit, a rotational orientation detector, and an absolute location detection system in wireless communication with the unmanned aerial vehicle wherein the base station is configured to receive an absolute location data from the rotational orientation detector means and calculate an orientation of the unmanned aerial vehicle. The unmanned aerial vehicle can further comprise at least one of a pitch, roll and yaw corrector. The base station can be configured to generate an instruction to the unmanned aerial vehicle in response to the calculated orientation of the unmanned aerial vehicle. In alternative configurations, the instruction can be generated by an onboard CPU. The unmanned aerial vehicle can be autonomous such that the system is used to keep the antenna pointed as desired. The instructions to the unmanned aerial vehicle can changes one or more of a pitch, roll and yaw of the unmanned aerial vehicle.

Another aspect of the disclosure is directed to unmanned aerial vehicle systems comprising: an unmanned aerial vehicle having a fixed, directional antenna means, a rotational orientation detector means, an absolute location detection system, a flight control system and an azimuth computation unit; a base station having an RF transceiver, and a control station absolute location detection system in wireless communication with the unmanned aerial vehicle wherein the base station is configured to receive an absolute location data from the rotational orientation detector means and calculate an orientation of the unmanned aerial vehicle. In some configurations, the unmanned aerial vehicle further comprises at least one of a pitch, roll and yaw corrector. Additionally, the base station can be configured to generate an instruction to the unmanned aerial vehicle in response to the calculated orientation of the unmanned aerial vehicle. In alternative configurations, the instruction can be generated by an onboard CPU. The instruction to the unmanned aerial vehicle changes one or more of a pitch, roll and yaw of the unmanned aerial vehicle.

Still another aspect of the disclosure is directed to a method of controlling an unmanned aerial vehicle system comprising: an unmanned aerial vehicle having a fixed, directional antenna means, a rotational orientation detector means, an absolute location detection system, and a flight control system; a base station having an RF transceiver, an azimuth computation unit, a rotational orientation detector, and an absolute location detection system in wireless communication with the unmanned aerial vehicle wherein the base station is configured to receive an absolute location data from the unmanned aerial vehicle rotational orientation detector means and calculate an orientation of the unmanned aerial vehicle, the method steps comprising: establishing a wireless communication link between the aerial vehicle and the base station; determining a location of the unmanned aerial vehicle; calculating an instruction for the flight control system to change one or more of a pitch, roll and yaw of the unmanned aerial vehicle to change an orientation of the fixed, directional antenna means. Additional steps can include generating an instruction to the unmanned aerial vehicle in response to the calculated orientation of the unmanned aerial vehicle. Additional steps can include sending the instruction to the unmanned aerial vehicle from the base station.

Still another aspect of the disclosure is directed to a method of controlling an unmanned aerial vehicle system comprising: an unmanned aerial vehicle having a fixed, directional antenna means, a rotational orientation detector means, an absolute location detection system, a flight control system and an azimuth computation unit; a base station having an RF transceiver, and a control station absolute location detection system in wireless communication with the unmanned aerial vehicle wherein the base station is configured to receive an absolute location data from the rotational orientation detector means and calculate an orientation of the unmanned aerial vehicle, the method steps comprising: establishing a wireless communication link between the aerial vehicle and the base station; determining a location of the unmanned aerial vehicle; calculating an instruction for the flight control system to change one or more of a pitch, roll and yaw of the unmanned aerial vehicle to change an orientation of the fixed, directional antenna means. Additional steps can include generating an instruction to the unmanned aerial vehicle in response to the calculated orientation of the unmanned aerial vehicle. The method can also include sending the instruction to the unmanned aerial vehicle from the base station.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example:

U.S. Pat. No. 6,219,004 B1 issued on Apr. 17, 2001 to Johnson, for Antenna having hemispherical radiation optimized for peak gain at horizon;

U.S. Pat. No. 6,774,860 B2 issued on Aug. 10, 2004 to Downs, for UAV (unmanned air vehicle) serving dipole;

U.S. Pat. No. 7,302,316 B2 issued on Nov. 27, 2007 to Beard et al., for Programmable autopilot system for autonomous flight of unmanned aerial vehicles;

U.S. 8,265,808 B2 issued on Sep. 11, 2012 to Garrec et al., for Autonomous and automatic landing system for drones;

U.S. Pat. No. 8,904,880 B1 issued on Dec. 9, 2014 to Tillotson et al., for Methods and systems for low-cost aerial relay;

U.S. Pat. No. 8,907,846 B2 issued on Dec. 9, 2014 to Sharawi et al., for Single-antenna direction finding system for-multi-rotor platforms;

U.S. Pat. No. 9,075,415 B2 issued on Jul. 7, 2015 to Kugelmass, for Unmanned aerial vehicle and methods for controlling same;

U.S. Pat. No. 9,211,947 B2 issued on Dec. 15, 2015 to Miralles, for Unmanned aerial vehicle reorientation;

US 2014/0266882 A1 published on Sep. 18, 2014 to Metzger, for System and process for determining vehicle attitude; and

US 2015/0236779 A1 published on Aug. 20, 2015 to Jalali, for Broadband access system via drone/UAV platforms.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a perspective view of an exemplary omni-directional unmanned aerial vehicle (UAV) according to the present disclosure with a fixed, directional antenna mounted on a surface;

FIG. 1B is a perspective view of an exemplary omni-directional UAV with an exemplar antenna radiation pattern extending therefrom;

FIG. 1C is a portion of a side view of a UAV illustrating an exemplar angle between a surface of the UAV and an antenna extending from the surface of the UAV;

FIG. 2 is a block diagram illustrating the main components of one embodiment of the system according to the present disclosure;

FIG. 3 is a block diagram illustrating the main components of a second embodiment of the system according to the present disclosure;

FIGS. 4A-C are side views of a UAV according to the present disclosure with a fixed, directional antenna mounted on a surface positioned relative to a user (or base station) which illustrates a change in orientation of the UAV in response to at least one of a pitch-roll-yaw command to optimize the fixed antenna orientation to the base station;

FIGS. 5A-D are side views of a UAV according to the present disclosure with fixed, directional antennas mounted at an angle on the surface of the UAV which illustrates a change in orientation of the UAV in response to at least one of a pitch-roll-yaw command; and

FIG. 6 is a view of a UAV in communication with two base stations positioned relative to a plane parallel to the ground.

### DETAILED DESCRIPTION

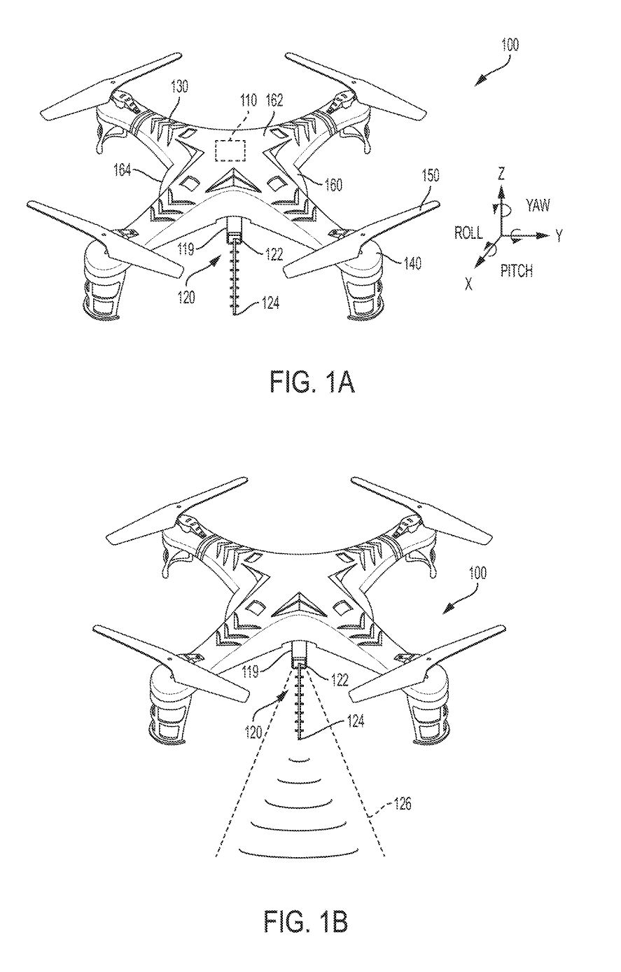

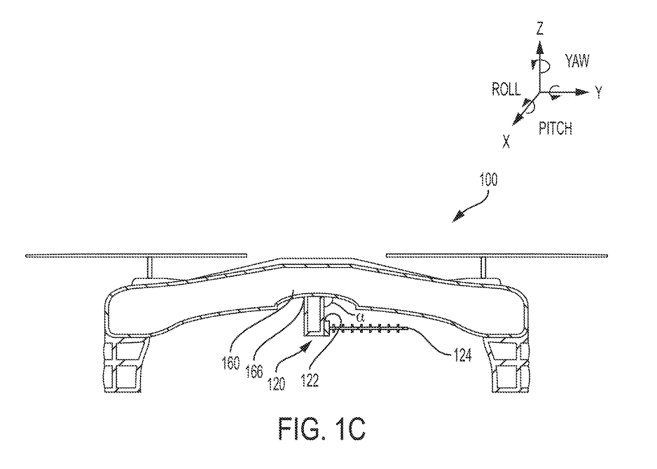

As shown in FIGS. 1A-C, the exemplar unmanned aerial vehicle 100 of the system includes, for example, a housing having a multi-rotor platform that includes four structural arms 130 extending therefrom and a rotor attached to each of the structural arms 130, thereby forming a omni-directional UAV (Unmanned Aerial Vehicle) or drone. Suitable UAV include, for example, a quad-copter as illustrated. Other configurations of a UAV can be employed without departing from the scope of the disclosure. A reference x-y-z diagram which illustrates relative pitch rotation about the y-axis, yaw rotation about the z-axis, and roll rotation about the x-axis.

Control electronics 110 are integrated into the UAV platform base 160. As illustrated, the UAV platform base 160 has an upper surface 162, four side surfaces 164, and a lower surface 166. These surfaces can be positioned so that the upper surface 162 is parallel to the lower surface 166 and the side surfaces 164 are at least partially perpendicular to a portion of the upper surface 162 and the lower surface 166. Other shapes and configurations for the UAV platform base 160 can be used without departing from the scope of the disclosure. Other configurations of UAV can be used without departing from the scope of the disclosure as will be appreciated by those skilled in the art.

As illustrated, a motor 140 and a propeller 150 are mounted at the end of each of the structural arms 130. Control electronics 110 are configurable to control the speed rates of each motor 140 mounted at the end of each structural arms 130 to cause the movement of the quad-rotor platform.

The fixed directional antenna 120 generates a signal 126 which emanates from the UAV 100. A suitable fixed directional antenna 120 can be a Yagi antenna as illustrated or any other suitable antenna. As will be appreciated by those skilled in the art, the strength of the signal 126 increases as the end of the fixed directional antenna 120 is optimally directed to a base station.

Affixed to the UAV platform is a single, fixed directional antenna 120 that exhibits superior reception in a preferred orientation. The fixed directional antenna 120 can be positioned so that a first end 122 is configured to engage a surface of the UAV platform base 160 and a second end 124 is at an opposite end from the first end 122. By controlling rotation of the UAV about, for example, its yaw axis, the system orients and maintains the antenna in a preferred azimuth orientation for best reception by a ground control station.

The fixed directional antenna 120 can be affixed to the UAV platform base 160 on any surface. Additionally, the fixed directional antenna 120 can be positioned so that the pitch of the fixed directional antenna 120 is at a 15-90 degree angle from a location at point of attachment on the surface of the UAV platform base 166. As shown in FIG. 1C the UAV platform base 160 has a plurality of planar surfaces and the fixed directional antenna 120 is positioned on an lower surface 166 at an angle α from the fixed directional antenna mounting surface that is substantially perpendicular to the planar lower surface 166. The angle is illustrated as 90 degrees from the point of attachment. Other angles can be used without departing from the scope of the disclosure. The angle of the fixed directional antenna 120 can be fixed or electronically or mechanically articulated.

A number of directional antennas are suitable for use with this device. Examples include axial mode helical antenna, Yagi antenna, patch antenna, traveling wave horn antenna, reflective dish antenna, and panel array of patch, bowtie or dipole elements antennas. Directional antennas can have, for example, a 7-60 degree radiation pattern, a 0.25-3 mile range, and an 8-24 dBi gain. However, as will be appreciated by those skilled in the art, a directional antenna deliberately focuses energy in a specific direction along a line. The exact gain, radiation pattern and functional ranges could vary from the example provided.

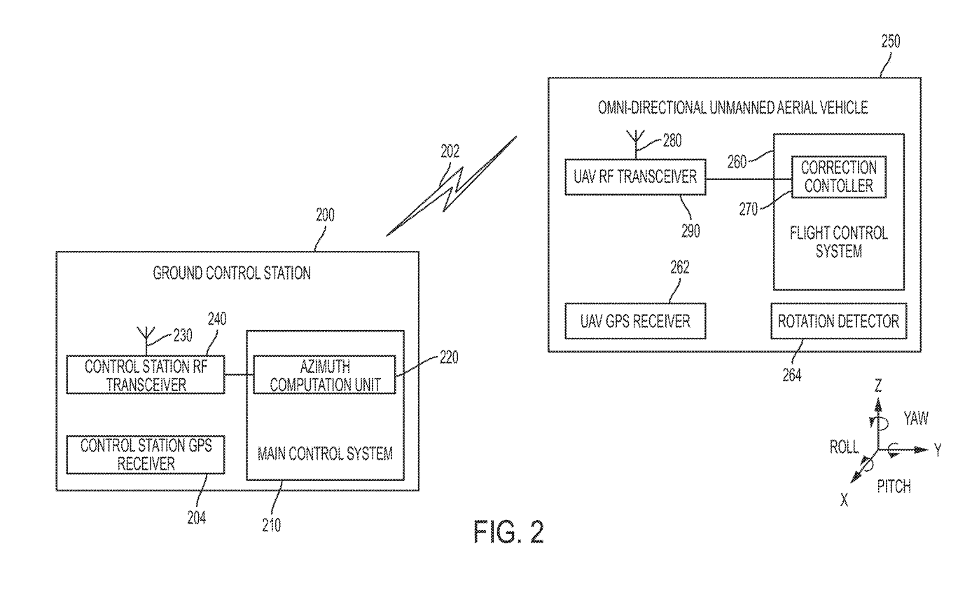

FIG. 2 is a block diagram of an embodiment of the system according to the present disclosure. The system comprises a ground control station 200 and a UAV 250, such as the UAV described in FIGS. 1A-C. The ground control station 200 is capable of wireless communication 202 with the UAV 250 via, for example, radio frequency (RF).

The ground control station 200 includes a control station absolute positioning system receiver such as GPS receiver 204, and a main control system 210. The main control system 210 includes an azimuth computation unit 220, a control station antenna 230 and a control station RF transceiver 240 for communication with the UAV 250.

The UAV 250 includes a UAV absolute positioning system receiver 262, a rotation detector 264 (such as a digital compass which detects a rotational orientation), a UAV directional antenna 280, and a UAV RF transceiver 290 for communication with the ground control station 200. The flight control system 260 contains a pitch-roll-yaw correction controller 270, which controls rotation of the UAV 250 about at least one axis. As the UAV 250 traverses its flight path, the ground control station 200 receives the absolute positioning coordinates and digital compass heading of the UAV 250 via RF transmission. From the absolute position location of the UAV 250 and its own absolute positioning location via control station absolute positioning system receiver, such as GPS receiver 204, the azimuth computation unit 220 calculates a vector representing the path from the drone to the ground station. Comparison of this vector to the current orientation of the drone based on digital compass heading allows for the calculation of a correction command. The correction command is then transmitted via control station RF transceiver 240 to the UAV RF transceiver 290 which, in turn, routes it to the correction controller 270 of the flight control system 260. The orientation correction is executed by the flight control system 260 to attain desired antenna orientation with respect to the ground control station 200. Periodic repetition of this process at an appropriate interval enables the UAV 250 to maintain desired antenna orientation with respect to the ground control station 200. Both the UAV and the ground station have an absolute positioning system, such as a GPS. Other absolute positioning systems can be used in either or both the UAV and the ground station without departing from the scope of the disclosure. Additionally, both the UAV and the ground station can have a rotational orientation detector, for example a digital compass. Other rotational orientation detectors can be used in either or both the UAV and the ground station without departing from the scope of the disclosure.

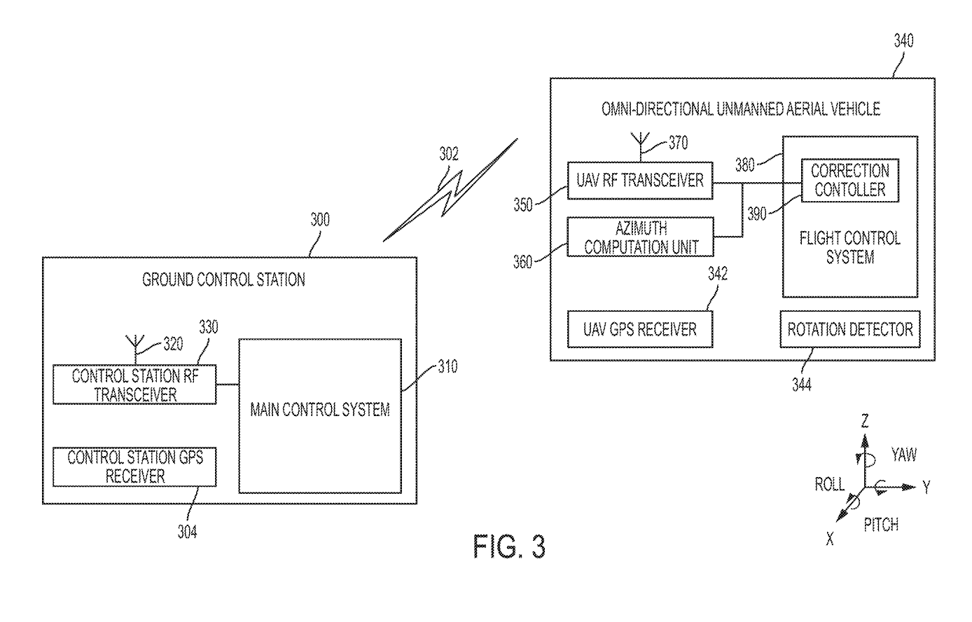

FIG. 3 is a block diagram of another embodiment of the system according to the present disclosure. The system comprises a ground control station 300 and a UAV 340, such as the UAV described in FIGS. 1A-C. The ground control station 300 is capable of wireless communication 302 with the UAV RF transceiver 350 via, for example, radio frequency (RF).

The ground control station 300 includes a control station absolute positioning system receiver, such as GPS Receiver 304, a main control system 310, an antenna 320 and a control station RF transceiver 330 for communication with the UAV 340. The UAV 340 includes an absolute positioning receiver, such as UAV GPS receiver 342, a rotational orientation detector, such as digital compass 344, a UAV RF transceiver 350 for communication with the ground control station 300, an azimuth computation unit 360, a directional antenna 370 and a flight control system 380, which itself contains a correction controller 390. As the UAV 340 traverses its flight path, it receives absolute positioning coordinates, such as GPS coordinates, from the ground control station 300. In the case where the ground control station 300 is stationary, the coordinates need only be entered and recorded by the UAV 340 once prior to the flight. This may be accomplished via RF transmission, or via a number of other means, including wired connection, infrared transmission, or even manual setting of switches on the UAV 340.

Using the absolute positioning coordinates from the ground control station 300, such as GPS coordinates, along with absolute positioning coordinates from the UAV GPS receiver 342, the azimuth computation unit 360 computes a vector representing the path from the drone to the ground station. Comparison of this vector to the current orientation of the directional antenna 370, based on a reading from the digital compass 344 enables the azimuth computation unit to calculate a correction command. The correction command is submitted to the correction controller 390 of the flight control system 380 which executes it to maintain proper azimuth orientation of the directional antenna 370 with respect to the ground control station 300. Periodic repetition of this process at an appropriate interval enables the UAV 340 to maintain desired antenna orientation with respect to the ground control station 300.

The UAV flight control system is configurable to maintain a periodic log of location, orientation, and signal quality data. In the event that communication with the ground control station 300 is lost for any reason, the flight control system 380 will command the UAV 340 back to the last position and orientation whereupon it had acceptable signal quality in order to re-establish communication with the ground control station 300.

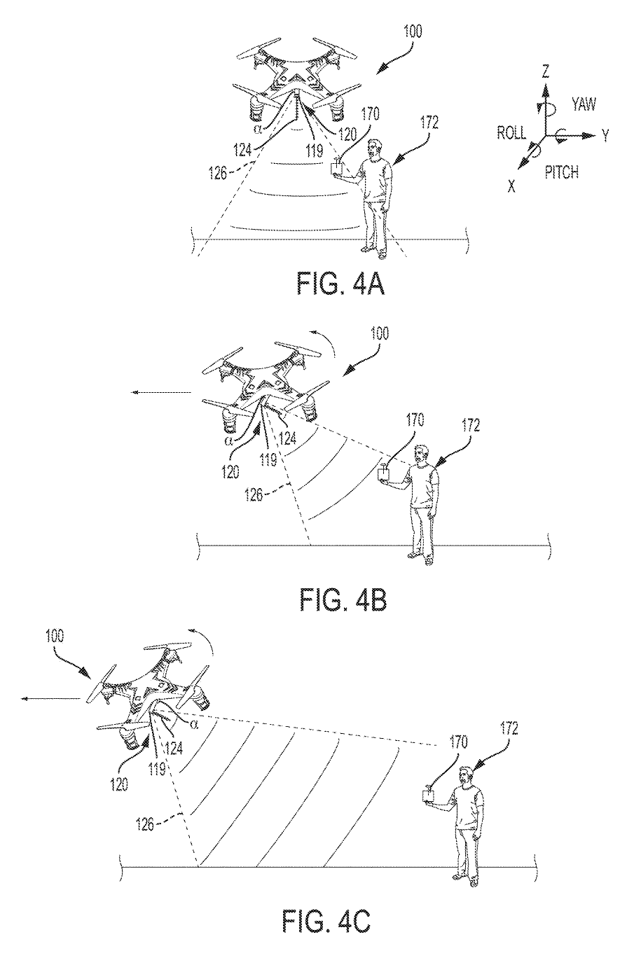

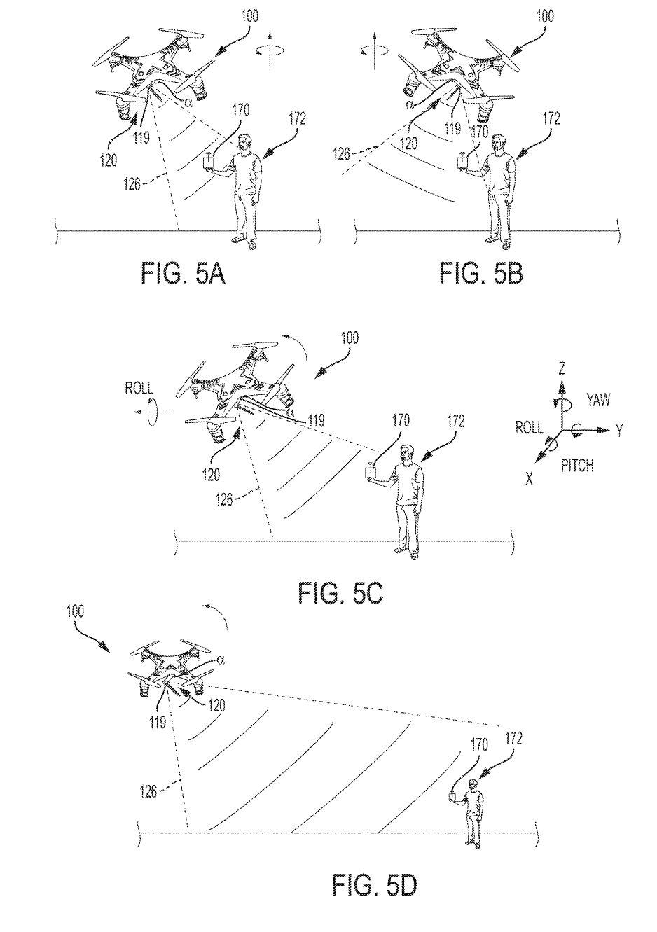

FIGS. 4A-C are side views of a UAV platform base 160 according to the present disclosure with a fixed, directional antenna 120 mounted on a surface positioned relative to a user 172 (or ground control station 170). The fixed, directional antenna 120 is attached to a lower surface 166 of the UAV platform base 160 so that the antenna extends from the UAV platform base at an angle α of 90 degrees from the surface of the UAV platform base 160. A signal 126 is emitted from the fixed, directional antenna 120. The signal 126 extends from the end of the fixed, directional antenna 120 and covers a defined signal area. As the UAV 100 moves away from the ground control station 170, the strength of the signal 126 changes. In one configuration, as the UAV 100 moves away from the ground control station 170, a determination is made of the location of the UAV 100 and the strength of the signal 126. The strength of the signal 126 can be a perceived signal strength, which can be compared against a known signal strength range for the antenna. A ground control station 170 communicates with the UAV 100 via the fixed, directional antenna 120. Because the antenna is a fixed, directional antenna 120, instructions sent from the ground control station 170 to the UAV 100 can include directions to alter the orientation of the UAV 100 relative to the ground control station 170 to optimize the signal strength.

Where the fixed, directional antenna 120 is mounted at an angle less than 90 degrees to a lower surface of the UAV 100, as the UAV moves upward (along, for example, the y-axis) away from the ground control station 170 (e.g., base station), a correction of one or more of roll and yaw would be expected as shown in FIGS. 5A-D. However, as the UAV moves away from the base station (along, for example, the x-axis), a correction of one or more of the yaw, roll and the pitch may be commanded to optimize orientation of the fixed, directional antenna towards the base station.

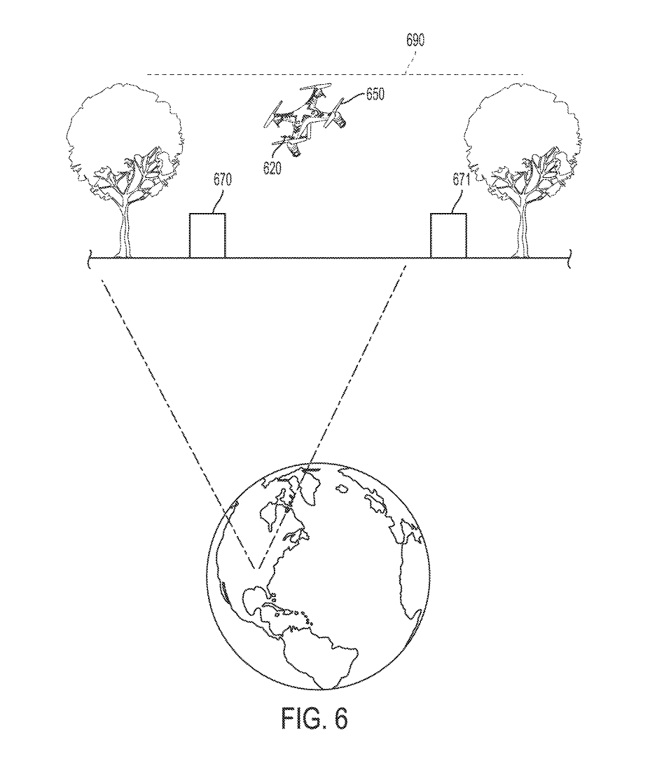

FIG. 6 illustrates a UAV with a transceiver 650 for communicating with a first base station 670 and a second base station 671 via antenna 620. The UAV is rotational to a plane 690 that is parallel to the earth's surface. Rotating the UAV can be achieved by using a radio direction finding, a visible compass, visual recognition by the UAV of visible landmarks, observation of astronomical bodies (e.g., moon, sun, stars). The computation of azimuth for the UAV antenna can be performed at one of the ground control stations or on the UAV itself.

The method includes: (1) activating the UAV; (2) determining a signal strength by the base station; (3) directing the UAV to move in a desired direction; (4) determine a change in signal strength as the UAV moves away from the base station; (5) in response to a change in signal strength instruct the UAV to rotate about at least one of an x-y-z axis; (6) continue instructing the UAV to rotate until an optimized signal strength is received. The UAV is rotated about one or more axis to point the antenna regardless of the direction of flight of the UAV.

Another method can include: (1) activating the UAV; (2) determining a signal strength by the base station; (3) directing the UAV to move in a desired direction; (4) calculate an anticipated change in signal strength based on the direction that the UAV is instructed to move relative to the base station; (5) instruct the UAV to rotate about at least one of an x-y-z axis as a result of an anticipated change in signal strength; (6) measure actual signal strength; (7) continue instructing the UAV to rotate until an optimized signal strength is received.

Still another method can include: (1) activating the UAV; (2) determining a signal strength by the base station; (3) directing the UAV to move in a desired direction; (4) maintain a log of physical location of UAV and signal strength from base station; (5) confirm communication link between UAV and base station; (6) if signal link with base station is lost, UAV refers to log of physical location and signal strength and returns to most recent location where communication link was active and assume orientation, continue through prior locations until signal connection is retained. This method can also skip locations as the UAV moves through the log of locations. Additionally, the UAV can assume the orientation associated with the location on the log and then, if that location and orientation does not result in a connection, rotate about one or more axis in an effort to locate a signal—thus compensating for any movement of the base station.

Yet another method can include situations where the UAV automatically establishes a communication link, determines a location of a base station and then positions the UAV so that the fixed directional antenna points at the base station.

As will be appreciated by those skilled in the art, the disclosed systems and methods may also utilize a variety of computer and computing systems, communications devices, networks and/or digital/logic devices for operation. Each may, in turn, be configurable to utilize a suitable computing device that can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as a smart phone (e.g., iPhone®), a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web browser, e.g., to provide access to applications and data and other content located on a website or a webpage of a website.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method that may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at some times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An unmanned aerial vehicle system comprising:
an unmanned aerial vehicle having a fixed, directional antenna, a rotational orientation detector, an absolute location detection system, and a flight control system;
a base station having an RF transceiver, an azimuth computation unit, a rotational orientation detector, and an absolute location detection system in wireless communication with the unmanned aerial vehicle wherein the base station is configured to receive an absolute location data from the unmanned aerial vehicle and calculate an orientation of the unmanned aerial vehicle.

2. The unmanned aerial vehicle system of claim 1 wherein the unmanned aerial vehicle further comprises a yaw corrector.

3. The unmanned aerial vehicle system of claim 1 wherein the base station is configured to generate an instruction to the unmanned aerial vehicle in response to the calculated orientation of the unmanned aerial vehicle.

4. The unmanned aerial vehicle system of claim 3 wherein the instruction to the unmanned aerial vehicle changes one or more of a pitch, roll and yaw of the unmanned aerial vehicle.

5. An unmanned aerial vehicle system comprising:
an unmanned aerial vehicle having a fixed, directional antenna, a rotational orientation detector, an absolute location detection system, a flight control system and an azimuth computation unit;
a base station having an RF transceiver, and a control station absolute location detection system in wireless communication with the unmanned aerial vehicle wherein the base station is configured to receive an absolute location data from the unmanned aerial vehicle rotational orientation detector and calculate an orientation of the unmanned aerial vehicle.

6. The unmanned aerial vehicle system of claim 5 wherein the unmanned aerial vehicle further comprises a yaw corrector.

7. The unmanned aerial vehicle system of claim 5 wherein the base station is configured to generate an instruction to the unmanned aerial vehicle in response to the calculated orientation of the unmanned aerial vehicle.

8. The unmanned aerial vehicle system of claim 7 wherein the instruction to the unmanned aerial vehicle changes one or more of a pitch, roll and yaw of the unmanned aerial vehicle.

9. A method of controlling an unmanned aerial vehicle system comprising:
an unmanned aerial vehicle having a fixed, directional antenna, a rotational orientation detector, an absolute location detection system, and a flight control system;
a base station having an RF transceiver, an azimuth computation unit, a rotational orientation detector, and an absolute location detection system in wireless communication with the unmanned aerial vehicle wherein the base station is configured to receive an absolute location data from the unmanned aerial vehicle and calculate an orientation of the unmanned aerial vehicle, the method steps comprising
establishing a wireless communication link between the unmanned aerial vehicle and the base station;
determining a location and orientation of the unmanned aerial vehicle;
calculating an instruction for the flight control system to change one or more of a pitch, roll and yaw of the unmanned aerial vehicle to change an orientation of the fixed, directional antenna.

10. The method of claim 9 further comprising generating an instruction to the unmanned aerial vehicle in response to at least one of the calculated orientation of the unmanned aerial vehicle and the location of the unmanned aerial vehicle.

11. The method of claim 10 further comprising sending the instruction to the unmanned aerial vehicle from the base station.

12. A method of controlling an unmanned aerial vehicle system comprising:
an unmanned aerial vehicle having a fixed, directional antenna, a rotational orientation detector, an absolute location detection system, a flight control system and an azimuth computation unit;
a base station having an RF transceiver, and a control station absolute location detection system in wireless communication with the unmanned aerial vehicle wherein the base station is configured to receive an absolute location data from the unmanned aerial vehicle rotational orientation detector and calculate an orientation of the unmanned aerial vehicle, the method steps comprising
establishing a wireless communication link between the unmanned aerial vehicle and the base station;
determining a location of the unmanned aerial vehicle;
calculating an instruction for the flight control system to change one or more of a pitch, roll and yaw of the unmanned aerial vehicle to change an orientation of the fixed, directional antenna.

13. The method of claim 12 further comprising generating an instruction to the unmanned aerial vehicle in response to the calculated orientation of the unmanned aerial vehicle.

14. The method of claim 13 further comprising sending the instruction to the unmanned aerial vehicle from the base station.

15. An unmanned aerial vehicle system comprising:
an unmanned aerial vehicle means having a fixed, directional antenna means, a rotational orientation detector, an absolute location detection system, and a flight control system;
a base station means having an RF transceiver, an azimuth computation unit, a rotational orientation detector, and an absolute location detection system in wireless communication with the unmanned aerial vehicle wherein the base station means is configured to receive an absolute location data from the unmanned aerial vehicle and calculate an orientation of the unmanned aerial vehicle.

16. The unmanned aerial vehicle system of claim 15 wherein the unmanned aerial vehicle further comprises a yaw corrector.

17. The unmanned aerial vehicle system of claim 15 wherein the base station is configured to generate an instruction to the unmanned aerial vehicle in response to the calculated orientation of the unmanned aerial vehicle.

18. The unmanned aerial vehicle system of claim 17 wherein the instruction to the unmanned aerial vehicle changes one or more of a pitch, roll and yaw of the unmanned aerial vehicle.

19. An unmanned aerial vehicle system comprising:
an unmanned aerial vehicle means having a fixed, directional antenna means, a rotational orientation detector, an absolute location detection system, a flight control system and an azimuth computation unit;
a base station means having an RF transceiver, and a control station absolute location detection system in wireless communication with the unmanned aerial vehicle wherein the base station means is configured to receive an absolute location data from the unmanned aerial vehicle rotational orientation detector and calculate an orientation of the unmanned aerial vehicle.

20. The unmanned aerial vehicle system of claim 19 wherein the unmanned aerial vehicle further comprises a yaw corrector.

21. The unmanned aerial vehicle system of claim 19 wherein the base station is configured to generate an instruction to the unmanned aerial vehicle in response to the calculated orientation of the unmanned aerial vehicle.

22. The unmanned aerial vehicle system of claim 21 wherein the instruction to the unmanned aerial vehicle changes one or more of a pitch, roll and yaw of the unmanned aerial vehicle.

23. A method of controlling an unmanned aerial vehicle system comprising:
an unmanned aerial vehicle means having a fixed, directional antenna means, a rotational orientation detector, an absolute location detection system, and a flight control system;
a base station means having an RF transceiver, an azimuth computation unit, a rotational orientation detector, and an absolute location detection system in wireless communication with the unmanned aerial vehicle wherein the base station means is configured to receive an absolute location data from the unmanned aerial vehicle and calculate an orientation of the unmanned aerial vehicle, the method steps comprising
establishing a wireless communication link between the unmanned aerial vehicle and the base station;
determining a location of the unmanned aerial vehicle;
calculating an instruction for the flight control system to change one or more of a pitch, roll and yaw of the unmanned aerial vehicle to change an orientation of the fixed, directional antenna.

24. The method of claim 23 further comprising generating an instruction to the unmanned aerial vehicle in response to the calculated orientation of the unmanned aerial vehicle.

25. The method of claim 24 further comprising sending the instruction to the unmanned aerial vehicle from the base station.

26. A method of controlling an unmanned aerial vehicle system comprising:
an unmanned aerial vehicle means having a fixed, directional antenna means, a rotational orientation detector, an absolute location detection system, a flight control system and an azimuth computation unit;
a base station means having an RF transceiver, and a control station absolute location detection system in wireless communication with the unmanned aerial vehicle wherein the base station means is configured to receive an absolute location data from the unmanned aerial vehicle rotational orientation detector and calculate an orientation of the unmanned aerial vehicle, the method steps comprising
establishing a wireless communication link between the unmanned aerial vehicle and the base station;
determining a location of the unmanned aerial vehicle;
calculating an instruction for the flight control system to change one or more of a pitch, roll and yaw of the unmanned aerial vehicle to change an orientation of the fixed, directional antenna.

27. The method of claim 26 further comprising generating an instruction to the unmanned aerial vehicle in response to the calculated orientation of the unmanned aerial vehicle.

28. The method of claim 26 further comprising sending the instruction to the unmanned aerial vehicle from the base station.
